(19) United States
(12) Patent Application Publication
(10) Pub. No.: US 2009/0230094 A1
(43) Pub. Date: Sep. 17, 2009

(54) Open-top welding chamber

(76) Inventor: Joseph E. Corne, Mission Viejo, CA (US)

Correspondence Address: JOSEPH E. CORNE, 27095 VIA CALLADO, MISSION VIEJO, CA, 92691, US

(21) Appl. No.: 12/075,756

(22) Filed: Mar. 14, 2008

(51) Int. Cl. B23K 9/32; B23K 35/38

(52) U.S. Cl. 219/74; 312/31

(57) ABSTRACT

A novel type of welding chamber for welding refractory metals such as titanium, that is open on the top rather than completely enclosed like other welding chambers is disclosed. Pressurized argon, an inert gas, is introduced into the bottom chamber of the device through a diffuser. The argon is then forced to travel upward through a gas-permeable welding bed formed above the accumulation chamber, the welding bed made from a conductive and gas-permeable material. The present invention creates an argon cloud of substantially 100% argon for welding titanium and other refractory metals therein. The argon cloud is constrained by a curtain barrier and the property that argon is heavier than air. The argon cloud substantially stays in place when not disturbed by movement of air above it. Workpieces are placed into the argon cloud and onto the welding bed to be welded.

### FIELD OF THE INVENTION

This invention relates to inert-gas backup devices and enclosures used in the arc welding of titanium and other refractory metals.

### BACKGROUND OF INVENTION

Many exotic metals, such as titanium, cannot be welded in the presence of air without producing a weak and discolored weld. An inert gas such as argon may be used to displace the air surrounding the weld, thereby solving the problem. There are several popular solutions in use.

“Welding chambers” are available in the marketplace. The primary component of a welding chamber is either a rigid box-like enclosure or a semi-flexible balloon-like enclosure. In either case the enclosure is a sealed unit with the purpose of constraining a volume of gas. Workpieces to be welded are placed inside the chamber through a door, or zipper, or some other means of access. An arc-welding torch is present in the chamber and accessed with air-tight gloves provided in the chamber walls. The chamber is flooded with an inert gas such as argon which displaces the original air, forcing it out through a vent. The user places his hands into the gloves of the chamber and welds the workpieces. There are two problems with a welding chamber. It takes time to purge the air, sometimes over an hour. Secondly is the cost of a chamber. Many individuals and small companies cannot afford the investment.

A second popular method is to “jerry-rig” a homemade welding chamber using cardboard, plastic sheets or aluminum foil, holding it together with duct tape. Argon is usually introduced into the enclosure through a diffuser at a location lower that the workpiece. The argon, being heavier than air, pushes the air up and out a hole in the top of the enclosure. After welding the workpiece, the homemade welding chamber is disassembled and then reassembled over a new workpiece. The argon used in the enclosure is lost. Admittedly, some odd-shaped or large bulky workpieces may require this jerry-rigged method, but for smaller compact workpieces, it is a waste of time.

A third popular method is to weld “without a welding chamber.” The welder selects an arc-welding torch with a large cup, ¾ to 1 inch in diameter, to allow a large amount of argon to surround the weld to keep air away. Usually a trailing shield with a secondary inert gas supply is attached to the torch and used to cover the weld bead so no air can reach the bead until it has cooled sufficiently. Also, although the topside of the workpiece is protected by the argon, the backside is not. Air present on the backside of the hot workpiece will contaminate and weaken the weld. It becomes necessary to provide a third source of argon for the backside such as a custom copper backup bar with argon flowing through tiny holes. This method nearly always requires expensive automated equipment and is used for high production of very similar parts.

Accordingly, there is a demand for an inexpensive off-the-shelf device to help weld these exotic metal workpieces. The open-top welding chamber is such a device. It takes advantage of the fact that argon is heavier than air. The device provides both a cloud of argon to place the workpieces into, and grounding surface for the actual welding. It is compact and lightweight, making it portable. It is easy to setup and easy to store when not in use. The present invention accomplishes these objectives.

Further objects and advantages will become apparent from a consideration of the ensuing description and drawings.

### SUMMARY OF THE INVENTION

The present invention provides a cloud of argon for workpieces being welded assuring that the welded workpieces will not be contaminated by air. Also the invention serves as a ground for the workpieces making it unnecessary to use a ground clamp.

The present invention is comprised of three major components: the accumulation chamber, the welding bed, and the curtain barrier.

The metallic “accumulation chamber” is the largest component and supports the welding bed and curtain barrier. It contains an inlet to allow argon to be admitted into the chamber. Inside the accumulation chamber, the argon first goes through a diffuser which causes the argon to flow with minimum mixing with the air present in the accumulation chamber. The heavier than air argon quickly displaces the air in the accumulation chamber by forcing the lighter air up through the porous welding bed. A convenient grounding screw is provided so the device may be grounded to the welder's power supply.

The “welding bed” is a porous metallic material. First, it allows the air to escape from the accumulation chamber. Then it allows argon to flow evenly upward through its porous body creating a cloud of argon. Air is pushed up and away from the device. The welding bed, being in contact with the accumulation chamber, also becomes a grounded surface on which workpieces are placed to be welded. There is no need to attach a grounding clamp on the workpiece.

The “curtain barrier” is located above the welding bed. In the first embodiment, a plurality of posts made of rigid material is positioned vertically around the perimeter of the welding bed. A curtain of impervious flexible material stretches around the posts to serve as a barrier to hold the argon cloud in place.

The second embodiment of the invention incorporates an impervious rigid curtain barrier. Its form may be similar to the flexible curtain barrier in the first embodiment, or it may be a non-conductive plastic dome with an access hole in the top.

To use the open-top welding chamber, workpieces are placed carefully onto the welding bed so as not to disturb the argon cloud. The argon cloud surrounds the weld protecting it from air contamination. An arc-welding torch with an additional argon flow is used to weld the workpieces. A clean weld will be produced. One rule must always be adhered to. The welder must not make sudden or sweeping movements with his hands that will disturb argon cloud causing the air above to be pulled down into the work area.

In accordance with the invention, the open-top welding chamber is a device that provides an argon atmosphere for welding titanium and other refractory metals. The present device allows quick and easy use by the welder without having to purchase expensive welding systems or causing the welder to jerry-rig questionable argon backup systems. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective illustration of the open-top welding chamber in complete form showing the principal components: the accumulation chamber, the welding bed and the curtain barrier.

FIG. 2 is a perspective illustration of the open-top welding chamber with a cutaway of a portion of the curtain barrier showing the position of the welding bed. A second cutaway of the welding bed shows the diffuser in the accumulation chamber.

FIG. 3 is a perspective illustration demonstrating the argon cloud produced by the invention. Argon rising up from the porous welding bed, forces out air and is constrained by the curtain barrier. Excess argon is allowed to overflow and drop harmlessly off the sides of the device.

FIG. 4 is a section view showing the major components of the invention and illustrating the flow of argon from the diffuser into the accumulation chamber and its continued flow up through the welding bed where it creates the argon cloud which is held in place by the curtain barrier.

FIG. 5 is a perspective view of the second embodiment of the invention in which the curtain barrier is a dome of rigid material with an access hole in the top.

### DETAILED DESCRIPTION OF PREFERRED EMBODIMENTS

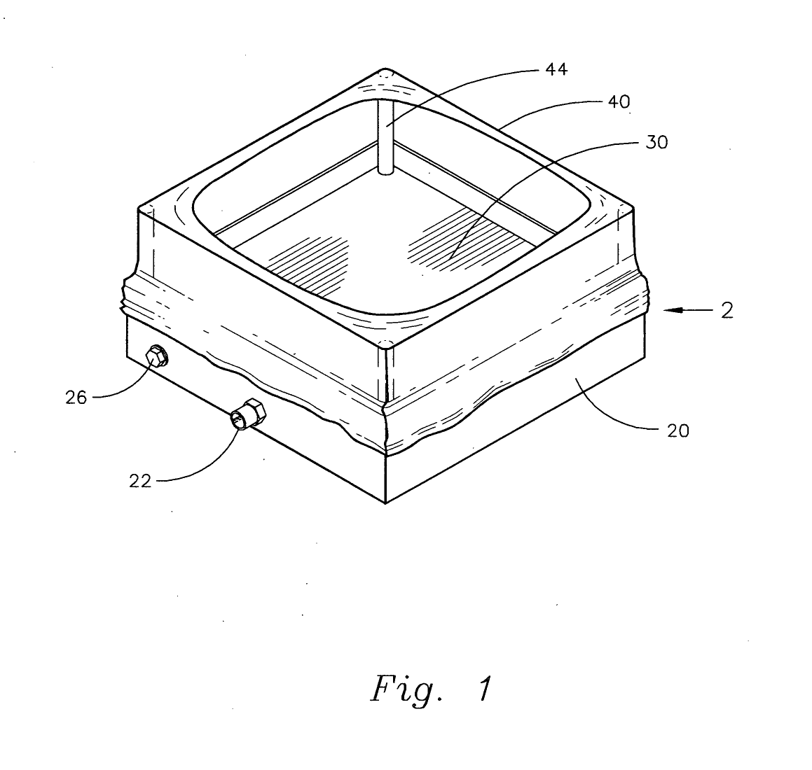

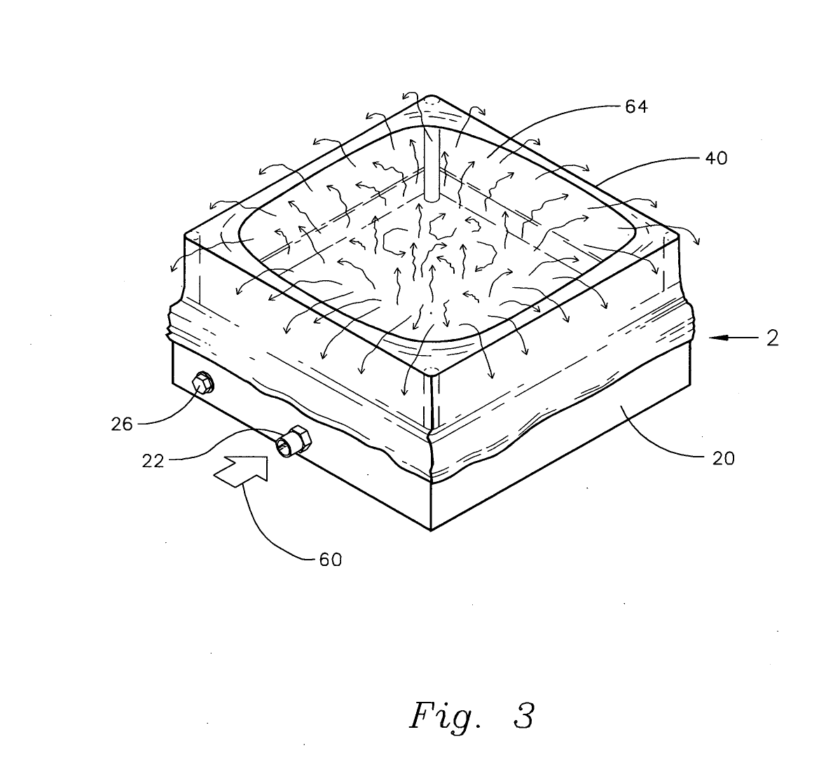

The present invention shown in FIGS. 1 & 3 is an open-top welding chamber 2 that provides a cloud of argon 64 used to exclude air from under and around a workpiece (not shown) that is to be arc-welded. It comprises an accumulation chamber 20, a welding bed 30 for supporting the workpiece to be welded, and a curtain barrier 40 constraining the argon cloud 64 (FIGS. 3 & 4) for the actual welding. The welding bed 30 must be porous and metallic. It could be made from one piece of sintered metal, or it could be a sandwich of various materials such as perforated metallic plates with a filler of steel wool or wire mesh between the plates. The curtain barrier 40 must be made of a non-porous, non-metallic material such as plastic, leather, oilcloth, or waterproof canvas to keep the argon cloud 64 in place.

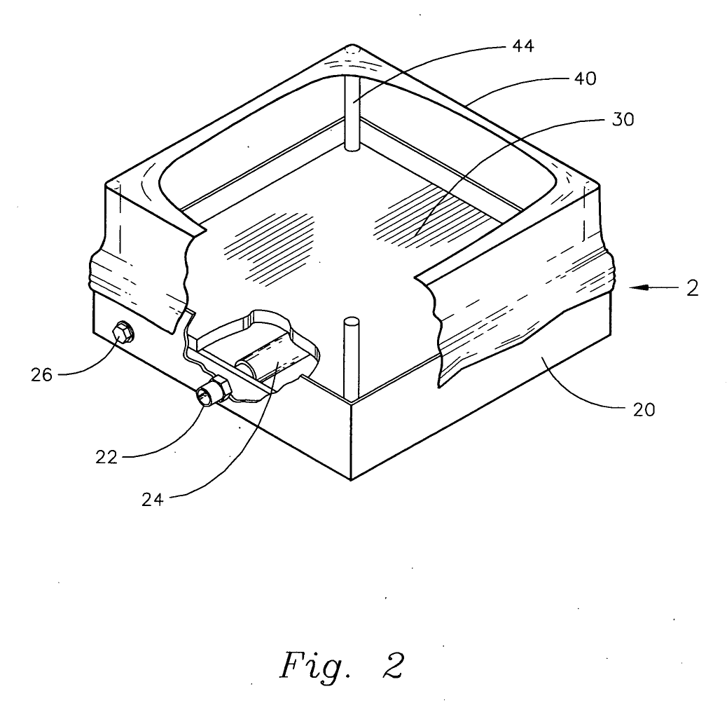

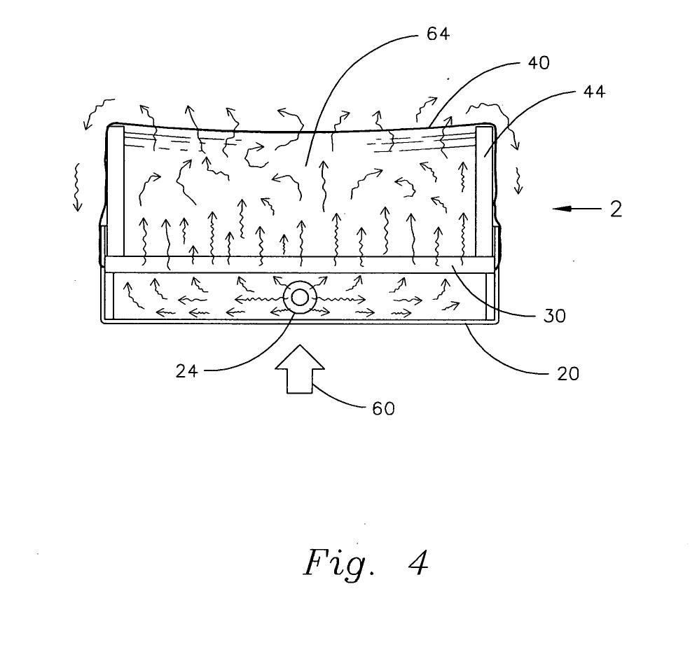

FIGS. 3 & 4 illustrate the entry of pressurized argon gas 60 from a standard argon hose (not shown) into the entry port 22 of the accumulation chamber 20. The argon gas 60 continues through a porous gas diffuser 24 (FIGS. 2 & 4) before the argon gas 60 is released into the accumulation chamber 20 (FIG. 4). The porous gas diffuser 24 could be made of sintered metal, porous ceramic, or a composite of materials. Within a few minutes of introducing the pressurized argon gas 60 into the entry port 22, the accumulation chamber 20 will contain nearly 100 percent argon gas 60.

The argon gas 60 in the accumulation chamber 20 is then forced up through the porous welding bed 30. A cloud of argon 64 is thereby created on the welding bed 30. In the first embodiment, the cloud of argon 64 (FIGS. 3 & 4) is constrained on all sides by a curtain barrier 40. The curtain barrier 40 is held in place by a plurality of substantial vertical posts 44 located on the perimeter of the welding bed 30. The argon cloud 64 tends to remain on the welding bed 30 because argon gas 60 is heavier than air and argon gas 60 is constantly refreshing the argon cloud 64.

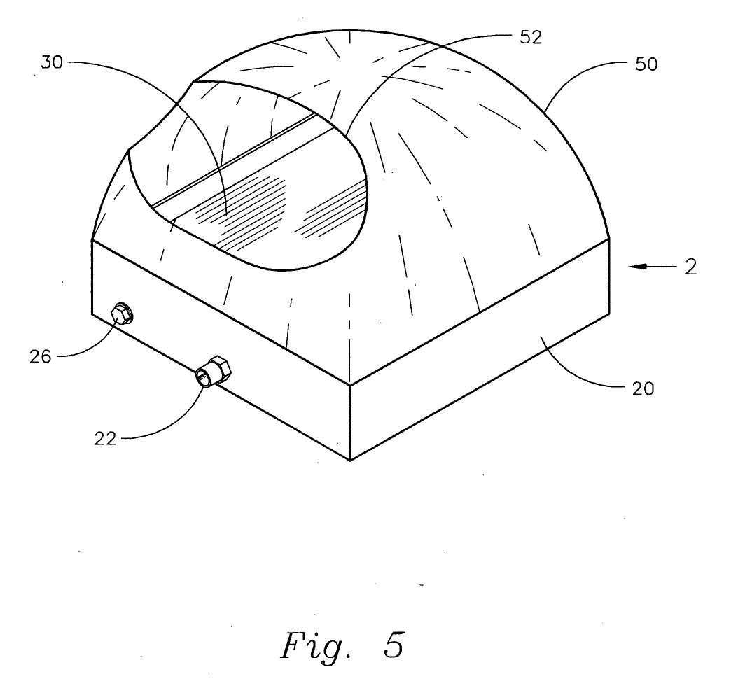

In the second embodiment (FIG. 5) the means of constraining the argon cloud 64 is a hard-material barrier 50 with an opening 52 on top for placing parts onto the welding bed 30.

The metallic accumulation chamber 20 also provides a means for grounding the open-top welding chamber 2. A grounding screw 26 is used to attach a grounding cable (not shown) to a welder's power supply (not shown). The metallic welding bed 30 resting on the accumulation chamber 20 thereby becomes grounded. A workpiece (not shown) placed on the welding bed 30 is also grounded thereby, so there is no need for a ground clamp (not shown) to be used to ground the workpieces.

While particular forms of the invention have been illustrated and described, it will be apparent that various modifications can be made without departing from the spirit and scope of the invention. For example, the exact materials used in the construction of the diffuser 24, the accumulation chamber 20, and the welding bed 30 may be modified extensively without changing the nature or scope of the invention. Accordingly, it is not intended that the invention be limited, except as by the appended claims.

I claim:

1. An inert-gas welding device for welding refractory metals, comprising;
an enclosed accumulation chamber containing a substantially hollow diffuser therein, the diffuser open to a gas input port and traversing the accumulation chamber;
a welding bed formed above the accumulation chamber, the welding bed made from a conductive and gas-permeable material; and
a curtain barrier above the welding bed, the curtain barrier made from a non-conductive, gas-impervious material, accessed at a top end,
whereby with argon introduced into the diffuser, air in the accumulation chamber is pushed up through the welding bed and out of the area constrained by the curtain barrier until the accumulation chamber, welding bed, and constrained area is substantially 100% argon.

2. The welding device of claim 1 wherein the gas-impervious curtain barrier is a flexible material held in place above the welding bed by a plurality of substantially vertical posts each fixed to the welding bed at a lower end thereof and to the curtain barrier at a top end thereof.

3. The welding device of claim 1 wherein a grounding screw is fixed to the accumulation chamber and electrically connected to the welding bed, whereby a workpiece in contact with the welding bed is electrically connected to the grounding screw.

4. The welding device of claim 1 wherein a diffuser is placed externally before the entry port rather than inside the accumulation chamber.

5. The welding device of claim 2 wherein the material used for the curtain barrier is substantially rigid, such as a plastic dome with an access hole, fixed at a lower end to the welding bed.
